(19) United States
(12) Patent Application Publication
(10) Pub. No.: US 2012/0278016 A1
(43) Pub. Date: Nov. 1, 2012

(54) DEVICE FOR MEASUREMENT OF MULITPLE CONFIGURATION TWO PHASE POWER WITH A SINGLE VOLTAGE INPUT

(76) Inventors: Joshua Blake Huff, Louisville, KY (US); Michael Francis Finch, Louisville, KY (US)

(21) Appl. No.: 13/547,243

(22) Filed: Jul. 12, 2012

Related U.S. Application Data
(63) Continuation-in-part of application No. 13/081,844, filed on Apr. 7, 2011.

(51) Int. Cl. G06F 19/00

(52) U.S. Cl. 702/62

(57) ABSTRACT

A power measurement device for use in a system susceptible to a plurality of potential voltage supply and current sensing connection configurations or states, operative to simulate the actual connection configuration and compute power consumed accordingly. The device includes a controller configured to receive a voltage supply input and a current measurement input; and a meter state selection device coupled to the controller, the meter state selection device being operative to selectively simulate a plurality of state settings, each state setting corresponding to a potential voltage and current sensing configuration state. The controller is operative to calculate a value of power consumed for each simulated potential configuration state, determine the simulated configuration state which provides maximum value for power consumed; and set the state of the meter state selection device to correspond to the configuration state which calculated the maximum value as the correct state for measuring power consumption.

### CROSS REFERENCE TO RELATED APPLICATIONS

This application is a continuation-in-part application of U.S. patent application Ser. No. 13/081,844, filed on Apr. 7, 2011, entitled “Device for Measuring Two Phase Power with Single Voltage Input”, the disclosure of which is incorporated herein by reference in its entirety.

### BACKGROUND

The present disclosure generally relates to energy management of household consumer appliances, and more particularly to monitoring power consumption in residential power applications.

In a typical, multi-phase, residential power system, the measurement of total power consumption requires a physical electrical connection between each input voltage leg and the measurement device. For a two-phase residential system, two separate connections are required, one for each voltage leg.

In a residential or home application, current measurements can be taken using clamp-on current transformers, one on each leg, generally referred to as L1 and L2. The current transformers can be placed inside the power distribution panel. Low voltage leads from the current transformers can be brought out to the measurement device, without the need to make any separate electrical connections within the power distribution panel. However, to obtain the L1 and L2 voltage measurements, two voltage references are needed. To obtain these voltage references, two separate electrical connections within the power distribution panel must be made. One to L1, and another two L2. These high voltage leads, which can be on the order of 120/240 VAC, must be brought from the power distribution panel to the measurement device. These connections must comply with safety and regulatory requirements.

To reduce the need for multiple electrical connections, measurement devices have been developed that use a single voltage source, along with additional circuitry, to measure power consumption in a single or polyphase environment. One example of a device that utilizes the voltage at the power outlet to measure voltage without making connections to the panel is disclosed in U.S. patent application Ser. No. 13/081,844. Since the measurement device needs to be powered to perform the measurement functions, the measurement device can calculate power consumption based on the voltage measured at the outlet used to energize the measurement device and the two separate current values on each leg, L1, L2.

It is not uncommon for one or both of the two current transformers that are used to measure the current values on each leg to be installed backwards. A current transformer has a top and a bottom, and can inadvertently be installed upside down in the power distribution panel. Also, each current transformer is connected to the measurement device using two electrical wires. These wires can be mistakenly installed backwards, or their connection points swapped. Also, in a typical residential or home polyphase power distribution system, the power outlets do not indicate which phase each leg is connected to. Thus, it is possible that an outlet that is intended to be providing a V1 voltage phase reference could rather be providing a V2 voltage phase reference. These types of errors will provide inaccurate power consumption measurements.

In a typical situation where the lines are reversed, the general solution is to open the power distribution panel, swap the current transformers or remake the connections, if the connections are wrong. The need to re-open the power distribution panel and remake connections poses, among other things, a number of safety and regulatory concerns.

Accordingly, it would be desirable to provide a system that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the disclosed embodiments relates to a power measurement device. In one embodiment the device includes a controller configured to receive a voltage supply input and a current measurement input; and a meter state selection device coupled to the controller, the meter state selection device comprising one or more state settings, each state setting corresponding to a potential configuration state of the voltage and current supply inputs. The controller is operative to calculate a value of power consumed using a mathematical model for each potential configuration state of the voltage and current supply inputs; determine which configuration state simulation computes the maximum value for the power consumed; which is deemed representative of the actual configuration and set the state of the meter state selection device to correspond to that power supply configuration state for making power consumption measurements.

Another aspect of the disclosed embodiments relates to a system for measuring power consumption of at least one device coupled to an AC power source. In one embodiment the system includes a controller comprising at least one voltage input for receiving a voltage from the AC power source to which the device is connected and at least one current measurement input for receiving values of measured current being drawn by the device, the controller comprising a memory in communication with a processor, the memory comprising program instructions for execution by the processor to calculate a power consumption of the device based on the at least one voltage input and the at least one current measurement input; a meter state selection device coupled to the controller, the meter state selection device being configured to process the voltage input data by changing a state of the at least one voltage input measurement for calculating the power consumption of the device, the memory comprising program instructions for execution by the processor to calculate the power consumption for each potential configuration state of the voltage input as set by the meter state selection device; determine a state of the voltage input in which the calculated power consumption is at a maximum value; and set a state of the meter state selection device to correspond to the state of the voltage input in which the calculated power consumption is at the maximum value.

Another aspect of the disclosed embodiments relates to a computer program product for determining a power supply configuration state of a load coupled to a power measurement device. In one embodiment, the computer program product includes computer readable code means, the computer readable program code means when executed in a processor device, being configured to calculate a value of power consumed for each potential power supply configuration state for the power supply for the load coupled to the power measurement device; determine a power supply configuration state in which the calculated power consumed by the load is at a maximum value; and set a state of the power measurement device to correspond to the power supply configuration state of the load associated with the maximum power consumed value.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 illustrates an exemplary block diagram of a system for measuring power consumption in accordance with the aspects of the disclosed embodiments.

FIG. 2 illustrates a block diagram of an exemplary power measurement device incorporating aspects of the disclosed embodiments.

FIG. 3 illustrates a process flow diagram of one embodiment of power measurement in a device incorporating aspects of the disclosed embodiments.

FIG. 4 illustrates a block diagram of an exemplary power measurement device incorporating aspects of the disclosed embodiments.

FIG. 5 illustrates an exemplary process flow diagram of one embodiment of power measurement using the device illustrated in FIG. 4.

FIG. 6 illustrates a block diagram of an exemplary power measurement system incorporating aspects of the disclosed embodiments.

FIG. 7 illustrates an exemplary current measurement selection device incorporating aspects of the disclosed embodiments.

FIG. 8 illustrates a perspective view of one embodiment of a device incorporating aspects of the disclosed embodiments.

FIG. 9 illustrates a block diagram of another exemplary power measurement device incorporating aspects of the disclosed embodiments.

### DETAILED DESCRIPTION OF THE EXEMPLARY EMBODIMENTS OF THE DISCLOSURE

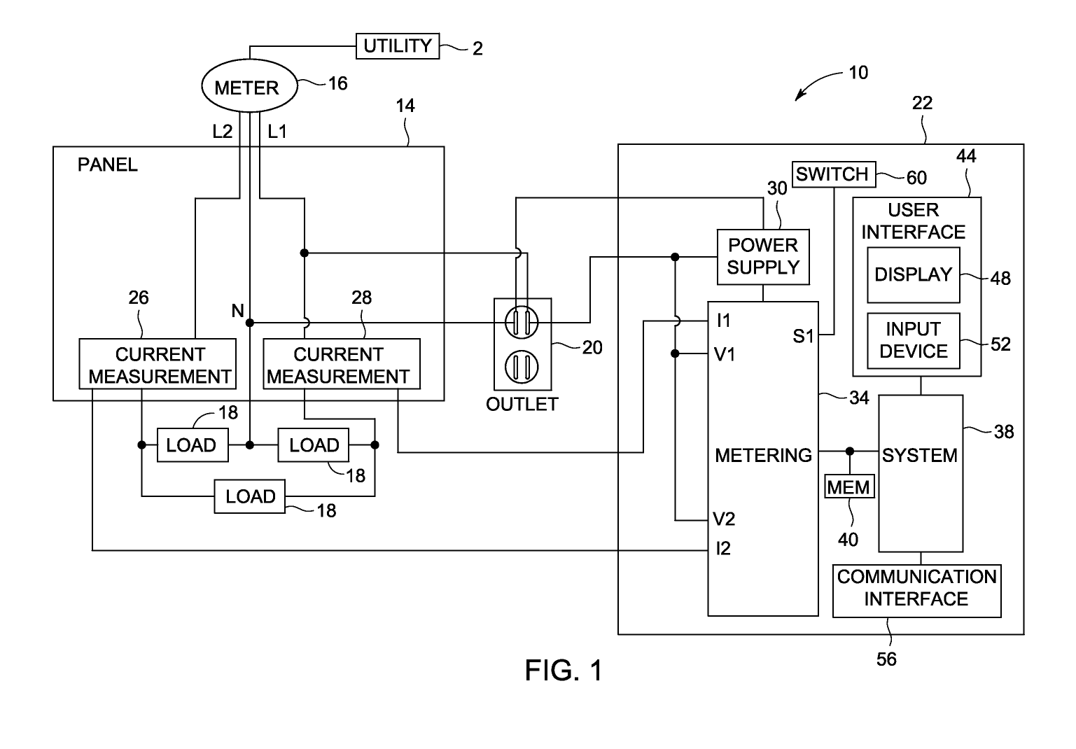

Referring to FIG. 1, an exemplary power distribution and measurement system 10 that can effectively measure power consumption in a single or polyphase environment, in multiple power connection configurations and when voltage and current phase connections are reversed or other-wise incorrectly connected is illustrated in schematic form.

As shown in FIG. 1, the system 10 generally includes a main power supply distribution panel 14 for receiving power from first and second power supply lines L1 and L2 and neutral line N. The first and second power supply lines L1, L2 and the neutral line N, are typically provided by a utility company via a meter 16, in a conventional residential application. The distribution panel 14 distributes the received power to one or more loads 18. The loads 18 are generally intended to include all loads that may be attached. For example, in one embodiment, the loads 18 can include circuit breakers in home main electrical panel. Loads 18 that require a 120 VAC supply can receive power via connections to L1 and N, or L2 and N. Loads 18 that require a 240 VAC supply can receive power via connections to L1 and L2. The loads 18 can include one or more electrical devices, such as appliances, connected to one or more outlets 20, which in this embodiment are shown as being served by L1 and N.

In one embodiment, as shown in FIG. 1, a power consumption measurement device 22 (also referred to herein as a metering device) is connected to the power supply outlet 20. The power consumption measurement device 22 generally includes a power supply 30 connected to the outlet 20 for receiving power therefrom. The power consumption measurement device 22 also includes a controller 34, (also referred to herein as a metering microcontroller unit). The controller 34 is generally configured to receive input voltage and current supply measurements and calculate power consumption based on the received voltage and current measurements. As will be understood in the art, power consumption can be calculated as a product of voltage and current. The controller 34 generally includes one or more processors that are operable to process the voltage and current inputs and calculate the consumed power, as is further described herein. In one embodiment, the controller 34 is comprised of machine-readable instructions that are executable by a processor and can include a memory 40 in communication with the processor, the memory 40 including program instructions for execution by the processor to execute the processes described herein.

The metering microcontroller unit 34 is configured to calculate the power consumption of the particular application, which for purposes of the description herein, is referred to as a residential application, such as a home.

In one embodiment, the device 22 includes a system controller 38 that is shown connected to the metering microcontroller unit 34. The system controller 38 is generally configured to interface between the metering microcontroller 34 and a user interface 44 and communication interface 56. Although the system controller 38 is shown as a device separate from the metering microcontroller unit 34, in one embodiment the two devices can be integrated into a single controller device. The controller 38 generally includes one or more processors that are operable to process the measurement values generated by the controller 34 and output that information to user interface 44 and communication interface 56, as needed and further described herein. In one embodiment, the controller 38 comprises machine-readable instructions that are executable by a processing device.

The user interface 44, which can include a display 48 and/or a user input device 52, is provided for interfacing with a user of the device 22. In one embodiment, the user interface 44 can include a touch screen display. Once the power consumption data is calculated, the data relating to the power consumption can be communicated to the user via the user interface 44. For example, the power consumption information, such as kilowatt hours consumed, can be displayed on the display 48. In one embodiment, the user interface 44 could be configured to display a colored indicator based on instantaneous power consumption. For example, a green indicator could be displayed when power consumption is below a certain threshold value, while a red indicator could be displayed when power consumption is above a certain threshold value. In alternate embodiments, any suitable displays and indicators can be used to provide power consumption information, such as for example, an alphanumeric display.

The system controller 38 can also be connected to a communication interface 56. In one embodiment, the communication interface 56 is a wireless module that is configured to connect with and/or communicate with a network, such as a Local Area Network (LAN) or the Internet. For example, the power consumption measurement device could be connected to the Internet for transmitting and/or receiving data relating to the calculated power consumption to a remote device or service, such as a server at a power company. The power consumption measurement device 22 could also be adapted to communicate with a home energy management device of a home energy management (HEM) system. An exemplary HEM system is described in commonly-assigned U.S. patent application Ser. No. 12/559,636, filed on Sep. 15, 2009, which is hereby incorporated by reference herein in its entirety.

Referring to FIG. 1, the metering microcontroller unit 34 has a pair of voltage inputs V1 and V2 for receiving a first supply voltage measurement, VL1, measured across L1 and N, which is the signal supplied to outlet 20, and a second supply voltage measurement, VL2, which would conventionally be measured across L2 and N. However, in the device 22, advantageous use is made of the relationship of the first voltage value VL1 measured across L1 and N, and the second voltage value VL2 measured across L2 and N, namely that voltage VL1 equals a negative VL2 (−VL2). So, rather than requiring a separate connection to supply input or leg L2, the voltage measurement VL1 from outlet 20 is applied to both voltage inputs V1 and V2 and the metering microcontroller 34 is configured to change the sign of the signal received at input V2, prior to calculating the power consumption.

Current transformers 26 and 28 are associated with power input line or leg L2 and L1, respectively. Each current transformer 28 and 26 provides a current measurement in the form of a voltage signal proportional to the current flowing in L1 and L2, respectively, to the respective first and second current inputs I1 and I2 of the power consumption measurement device 22. The metering microcontroller unit 34 is configured to calculate the power consumption based on the voltage of the power signal received at outlet 20 and provided to voltage inputs V1 and V2, and the two current values provided to the current inputs I1, I2, from the respective current transformers 28 and 26. This obviates the need to bring high voltage leads out of the power distribution panel 14. Although only two current transformers 26, 28 are shown in FIG. 1, in alternate embodiments, any suitable number of current transformers can be used.

A typical power measurement device captures an instantaneous voltage and an instantaneous current input measurement for each phase and then multiplies the instantaneous voltage by the instantaneous current. This measurement and calculation is performed many times per second. These values are then stored in a register and normalized to watt-seconds by dividing by the number of samples per second. The general equation used to describe the measurement of power consumption is:

$$Energy ≡ \int {\sum }_{i} {V}_{i} \cdot {I}_{i} d t ,$$

where V and I are the voltage and current in each phase, expressed in terms of a vector.

To calculate power consumption in a two-phase power system, such as the residential power system referred to herein, the equation above simplifies to:

Energy≡∫V₁·I₁+V₂·I₂dt

Since most residential home power installations in the United States rely on a 120VAC/240VAC supply, V₂ in the above equation equals −V₁. This means that the equation above can be further simplified to:

Energy≡∫V₁·I₁−V₁·I₂dt.

Thus, it will be appreciated that the single voltage source derived from, for example, the outlet 20, can be used by the power consumption measurement device 22 together with the current measurements from the current transformers arranged to measure the current in the two lines L1 and L2 delivering power to the home, to calculate the whole power consumption of this residential application. This eliminates the need for a separate electrical connection to the power distribution panel 14.

If the L1 and L2 wires are inadvertently reversed during installation, instead of a VL1 reference voltage, the outlet 20 provides a VL2 reference voltage. Similarly, if one of the current transformers 26, 28 is installed backwards, the sign of the current measurement for the backward transformer will be in error. Each of these potential configuration errors result in sign changes in the equations noted above, which can provide erroneous power consumption measurements. The aspects of the disclosed embodiments correct for such errors as hereinafter described.

In the embodiment of FIG. 1, the metering microcontroller 34 is configured to determine the state of the L1 and L2 connections. In this embodiment, to determine the state of the L1 and L2 connections, a load 18 is applied to the power delivered through the meter 16. Preferably the load 18 is a large consumer of power. Examples of such loads can include, but are not limited to electric appliances, such as an air conditioner, an electric range, or a clothes dryer.

With the load 18 activated, the metering microcontroller 34 measures the power consumption. If the measured value is a large, positive number, indicating that energy consumption is increasing rapidly, the L1 and L2 connections are correct. If the measured value is a large negative number, the L1 and L2 connections are reversed, and the voltage source is actually L2 or V₂. Thus, the equation above requires a sign change with respect to V₂ in the form of:

Energy≡−∫V₂·I₁−V₂·I₂dt

The metering microcontroller 34 is configured to modify the equation by changing the sign of the integral.

If the measured value is a relatively low value, this indicates that one of the current transformers 26, 28 is connected backwards and is reporting current with a sign change. This error can be resolved by changing the sign in the middle of the equation which indicates how to combine the two registers.

Energy≡∫V₁·I₁+V₁·I₂dt

The metering microcontroller 34 is configured to modify the equation above by changing the sign of V₁.

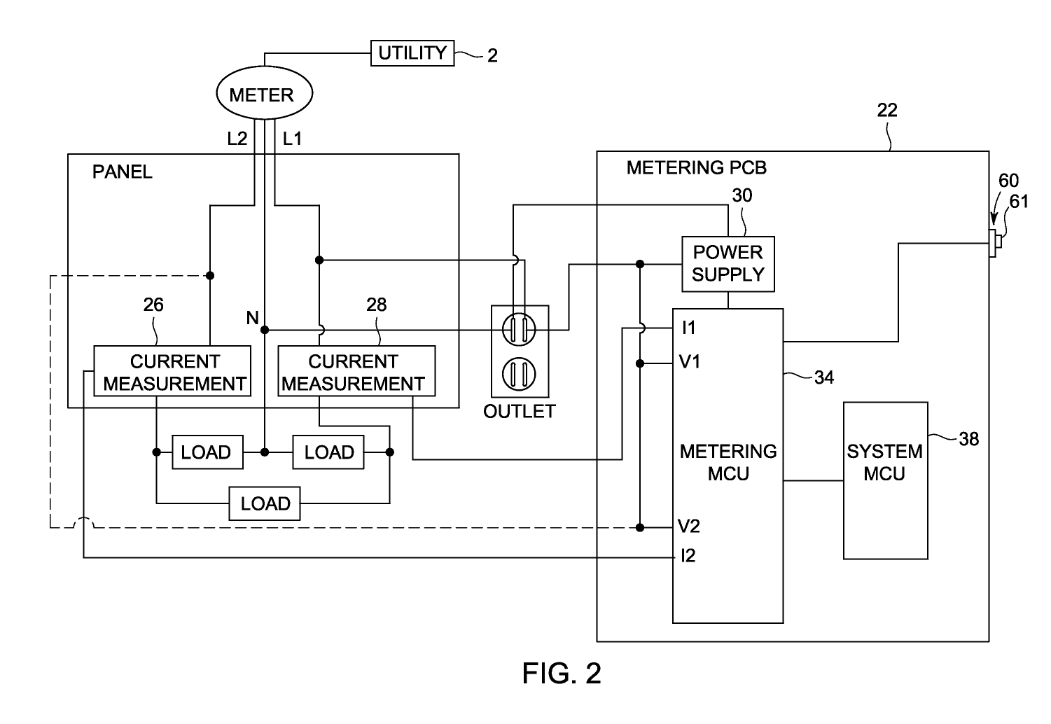

Referring to FIG. 2, in one embodiment, the user can configure the power measurement device 22 to correctly calculate the total power consumption based on the state of the L1 and L2 connections. In one embodiment, the measurement device 22 includes a meter state selection device 60. The meter state selection device 60 is generally configured to enable the metering microcontroller 34 to compensate for the voltage line connections L1, L2 being backwards or the current transformers 26, 28 being installed incorrectly.

As shown in FIG. 2, the meter state selection device 60 is coupled to the S1 input on the metering microcontroller 34. In one embodiment, the meter state selection device 60 comprises a push button 61 that, when activated, steps or cycles through each of the potential voltage line and current sensor configuration states, as will be hereinafter described with reference to Table 1. In another embodiment, the meter state selection device 60 can comprise one or more dip switches, where the different positions of the switches represent the different potential states. Although the examples herein are generally described with respect to a manually operated switch, the aspects of the disclosed embodiments are not so limited, and in alternate embodiments, the meter state selection device 60 can comprise an automatic or electronic switch unit that automatically changes, adjust or cycles through the states described below with respect to Table 1.

When initially configuring the power measurement device 22, loads are activated, as is described above. The metering microcontroller 34 measures the power consumption based on the I1, V1 and I2, V2 inputs, and provides an indication of the level of power consumption to the user, via for example, the user interface 44 illustrated in FIG. 1. In this example, the meter state selection device 60 has four states, each corresponding to a different mathematical model or mathematical formula for calculating the power consumed by the load 18. In one embodiment, the four states generally comprise 32 possible sensor/line connection configurations. Two voltage phase connection states, four V1, N,V2,N polarity configurations and four I1, I2 polarity configurations, for total of 32 potential configuration states. Each states is represented by one of the four power calculation formulas shown in Table 1, below. The necessary sign changes to accommodate the various combinations are represented by one of the four equations. In processing the V1, v2, I1, I2, data by all four equations results in one equation providing the maximum positive value. That equation should then be used for energy calculations for that particular configuration. Typically, the calculations will only need to be carried out one time, such as on the initial setup or installation. The calculations can also be triggered to be carried out in response to a specific event, such as for example, the installation of a solar panel after the installation of the device 22 of FIG. 1.

In a first state of the meter state selection device 60, or responsive to a first press of switch 61, the total power measured by the metering microcontroller 34 is determined by the equation Pₜₒₜₐₗ=(V₁*I₁)+(V₂*I₂), where V₁ represents the voltage input at V1, V₂ represents the voltage input at V2, I₁ represents the current at I1 and I₂ represents the current at I2. Table 1 below, illustrates each of the states and the corresponding power calculation formula. As shown in Table 1, in the First State of the meter state selection device 60, in response to a first press of switch 61, the total power measured by the metering microcontroller 34 is determined by the equation Pₜₒₜₐₗ=(V₁*I₁)+(V₂*I₂), where V₁ represents the voltage input at V1, V₂ represents the voltage input at V2, I₁ represents the current at I1 and I₂ represents the current at I2. This state corresponds to the configuration in which all of the connections are configured correctly, or the configuration in which L1 and L2 are reversed and current transformer 28 is installed backwards. The Second State represents a configuration in which the connections L1 and L2 are reversed and the current transformers are correctly installed, or a configuration in which L1 and L2 are correctly connected and current transformer 26 is reversed. The Third State represents a configuration in which the L1 and L2 connections are reversed and both current transformers are installed correctly, or a configuration in which L1 and L2 are correctly connected and current transformer 28 is installed backwards. The Fourth State represents a configuration in which L1 and L2 are reversed and current transformer 26 is installed backwards, or a configuration in which L1 and L2 are correctly connected and both current transformers are installed backwards. Thus the mathematical formula for correctly calculating the power for each of the potential physical configurations of the power lines L1 and L2 and current transformers 26 and 28 is represented by one of the States in Table 1.

TABLE 1

| | | |
|---|---|---|
| First State | Button Press 1 | Pₜₒₜₐₗ = (V₁ * I₁) + (V₂ * I₂) |
| Second State | Button Press 2 | Pₜₒₜₐₗ = (V₁ * I₁) − (V₂ * I₂) |
| Third State | Button Press 3 | Pₜₒₜₐₗ = (V₂ * I₂) − (V₁ * I₁) |
| Fourth State | Button Press 4 | Pₜₒₜₐₗ = −(V₂ * I₂) − (V₁ * I₁) |

Although the term “button press” is referred to above, it will be understood that the term “switch position(s)” could also be used, where the meter state selection device 60 requires user interaction. As shown in Table 1, each state has a slightly different mathematical model or formula for the power calculation, the difference being a sign change to account for each of the different current transformer and power line connection possibilities. In this embodiment, the state in which the calculated total power is greatest, is determined to be correct for the actual connection state of the power distribution panel 14, and is thereafter used to measure and calculate the total power. In one embodiment, the metering microcontroller 34 includes the meter state selection device 60, and is configured to automatically step through each of the different states shown in Table 1, determine the largest Pₜₒₜₐₗ value, and continue to calculate the total power consumed using the setting of the meter state selection device 60 that is associated with that particular state. Thus, the particular state can be user selected or automatically selected by the metering microcontroller 34.

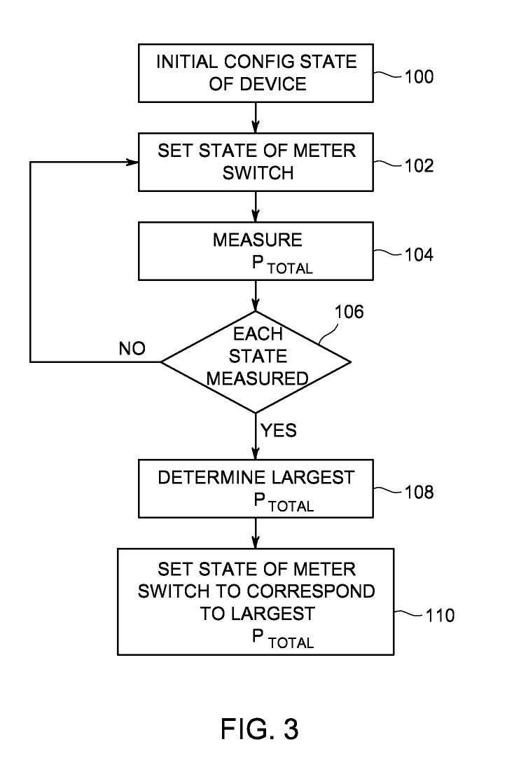

Referring to FIG. 3, one embodiment of a process flow for the power measuring device 22 shown in FIG. 2 is illustrated. The power measurement device 22 is set to an initial configuration state 100. The initial configuration state 100 generally includes connecting the power measurement device 22 to a power source, such as the outlet 20, and activating an electrical load 18. In one embodiment, the user interface 44 can provide a suitable indication to the user of the initial configuration state 100, such as the illumination of a light or LED, or displaying a message on the display 48 shown in FIG. 1. The meter state selection device 60 is set 102 to one of the states shown in Table 1. This includes selecting, as an initial starting state, one of the states illustrated in Table 1. Generally, the states can be indicated by a suitable indicator, such as an LED, the positions of a dip switch, or an alphanumeric message on the display 48. The total power, Pₜₒₜₐₗ, is measured 104, as is otherwise described herein. In one embodiment, the measured value can be stored in the memory device 40 of the system 10. It is determined 106, whether the Pₜₒₜₐₗ has been measured for each of the states shown in Table 1. If there is another state, the next state of the meter state selection device 60 is selected 102 and the Pₜₒₜₐₗ, for the next state is measured 104. If it is determined 106 that the Pₜₒₜₐₗ for total is each of the states shown in Table 1 has been measured, the largest Pₜₒₜₐₗ is determined 108. The state of the meter state selection device 60 is set 110 to correspond to the state in which Pₜₒₜₐₗ is largest. In one embodiment, the user iteratively makes the selection based on the feedback from the metering microcontroller 34 through the user interface 44, or the device 22 automatically selects the state in which the value of Pₜₒₜₐₗ is the largest.

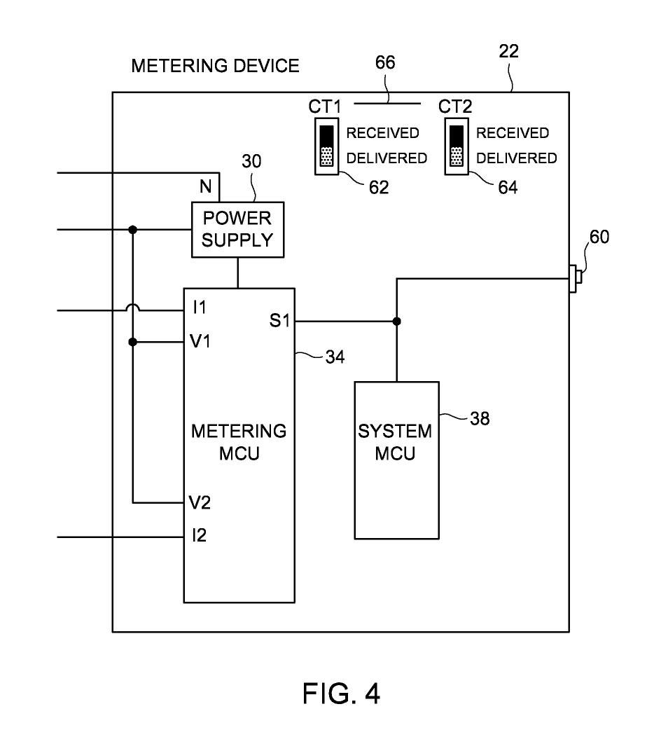

FIG. 4 illustrates another embodiment of the power measurement device 22. While the embodiments herein before described involve measuring power from the utility to a power consuming load, some residential power applications, such as solar energy, are capable of home power generation feeding back to the grid. These systems will generally be referred to as power generating systems. In this embodiment, the power measurement device 22 includes current transformer switching units 62 and 64, generally shown as current state selection device or switch 66. The current state selection device 66 is generally configured to compensate for whether the measured current flow is in a direction from the power distribution panel 14 or back to the grid. As noted above, if one of the current transformers 26, 28 is connected backwards, the current transformer will report current with a sign change. The current state selection device 66 is configured to adjust for the sign change so that the power consumption is properly calculated. Although the current state selection device 66 is shown as separate from the meter state selection device 60, in one embodiment, the current state selection device 66 can be integral with the meter state selection device 60, as well as the metering microcontroller 34. The microcontroller 34 can be coupled to or in communication with a processor that is operable to set the state corresponding to the operating function of each current transformer 26, 28. In one embodiment, the current state selection device 66 comprises machine-readable instructions that are executable by a processing device.

In one embodiment, each switching unit 62, 64 is associated with a current transformer 26 and 28, respectively. Generally, each switching unit 62, 64 will have two states or functions. The states are generally defined as “Received” for power coming into the power distribution panel 14 of FIG. 1, or “Delivered” referring to power being sent back to the grid. In one embodiment, the switching units 62 and 64 can comprise user selectable switching devices, where the user is able to manually select or switch the state of the respective current transformer 26, 28. Although two individual switches 62, 64 are shown in FIG. 4, in one embodiment a single switch with multiple poles can be used. In the example shown in FIG. 4, the switching units 62, 64 are manually operated switches. In another embodiment, the switching units 62 and 64 are electronic switches that are automatically configured to select an operating state of the respective current transformer 26, 28. Table 2 below, illustrates an exemplary state table for the state settings of the current state selection device 66 related to the connections of the current transformers 26, 28, in a power generating system application.

TABLE 2

| | CT 26 | CT 28 |
|---|---|---|
| STATE 1 | Receive | Receive |
| STATE 2 | Receive | Deliver |
| STATE 3 | Deliver | Receive |
| STATE 4 | Deliver | Deliver |

This embodiment finds application, for example, if a user desired to use two power measuring devices 22 independently. For example, if a user wanted to look at a solar panel with one power measuring device 22 and their water heater with the other power measuring device 22, each power measuring device 22 can be set independently and the algorithm illustrated with respect to Table 1 can be run, as is described above.

In another embodiment, depending on the user interface on for example a personal computer, it may be desirable for the user to select what they desire to measure. For example, if the system to be measured is solar panel that is generating power, the algorithm illustrated with respect to Table 1 is applied. In this case it can be advantageous for the power measurement device 22 to know that this to be a “Deliver” measurement, so that if the power measuring device 22 has to do some aggregation, it knows how to interpret this measurement.

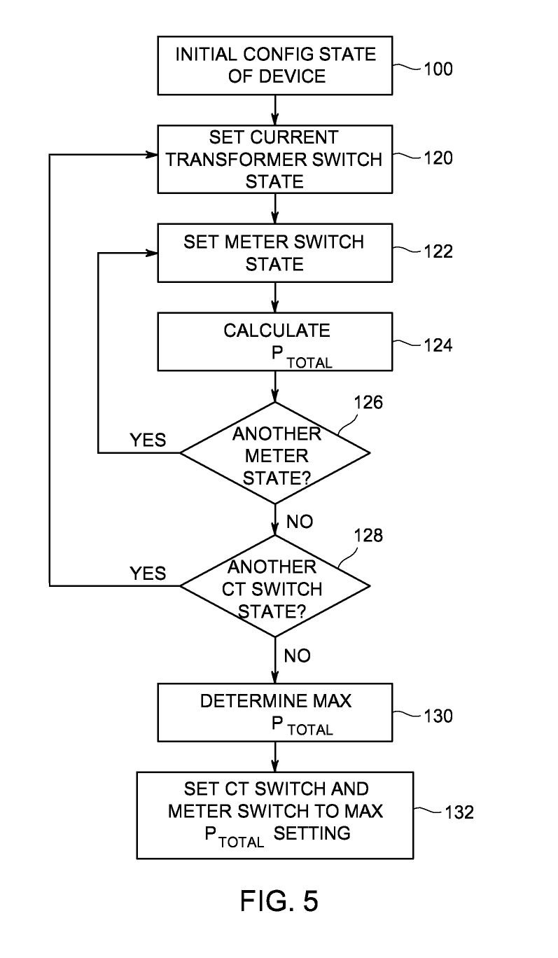

Referring to FIGS. 4 and 5, the measurement device 22 is set to the initial configuration state 100. A state of the meter state selection device 60, as described above with respect to Table 1, is selected or set 122. The operational function or state of each current transformer 26, 28 is set 120, by selecting or setting a state of the current state selection device 66, according to one of the states shown in Table 2. The total power consumption is measured 124. It is determined 126, whether the power consumption has been measured for each possible state shown in Table 1. If another state remains, the process is repeated until each state in Table 1 has been measured. Once the power has been measured for each state in Table 1, it is determined whether the power for each state of the current state selection device 66 shown in Table 2 has been measured. If not, the process is repeated for each state of the current state selection device 66. Once the power consumption for each state of the meter state selection device 60 and current state selection device 66 has been measured, the largest value for the total power consumption, Pₜₒₜₐₗ, is determined 130. The states of the meter state selection device 60 and the current state selection device 66 are set to correspond to the states corresponding to the maximum total power consumption. In one embodiment, the user iteratively selects, based on the feedback from the metering microcontroller 34 through the user interface 44, or the device 22 automatically selects, the state of the meter state selection device 60 and the current state selection device 66, in which the value of Pₜₒₜₐₗ is the largest.

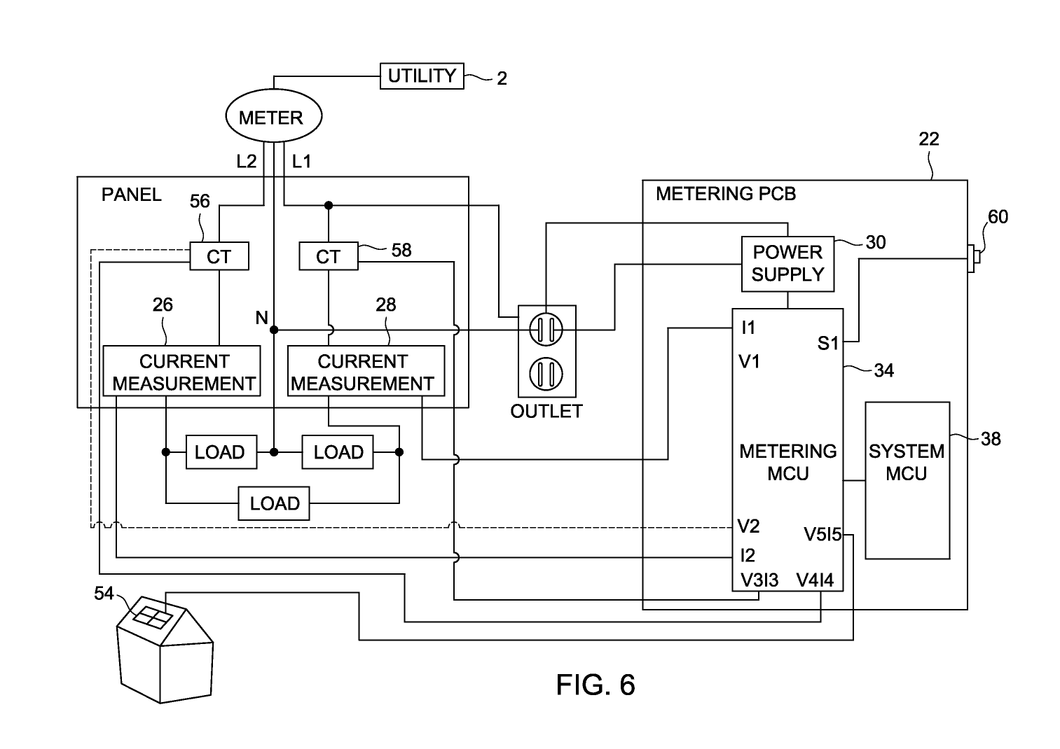

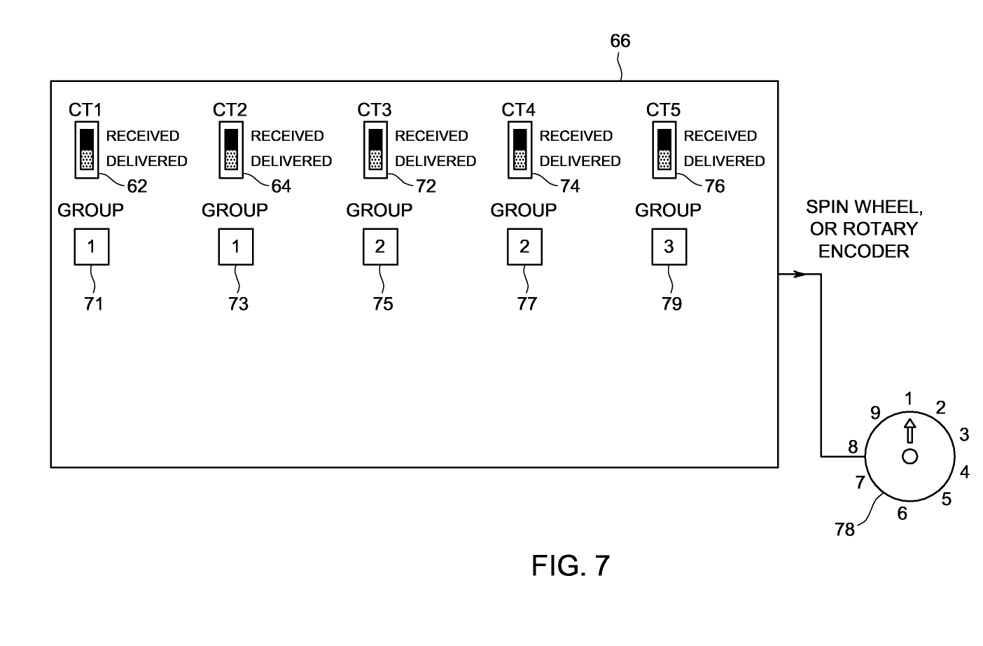

Although the aspects of the disclosed embodiments are generally described herein with respect to the use of two current measurement devices 26, 28, in alternate embodiments, any number of current measurement devices can be used, where each monitors a different device or appliance in the system 10. For example, in one embodiment, it may be desirable to separately monitor appliances such as heating and air-conditioning systems (HVAC) or solar panels. FIG. 6 illustrates one embodiment of a multiple current measurement device system. In this example, five current measurement devices, shown as current transformers 26, 28, 54, 56 and 58 are illustrated. Each current measurement device 26, 28, 54, 56 and 58 provides a voltage/current input to a respective VI input on the metering microcontroller 34, shown as I1V1, I2V2, I3V3, I4V4 and I5V5, respectively. As will be understood the microcontroller 34 can include any suitable number of such inputs, or multiple microcontrollers 34 can be coupled together. For each current measurement device 26, 28, 54, 56 and 58, the current state selection device 66 includes a corresponding current state switch, such as switches 62 and 64 shown in FIG. 4. FIG. 7 illustrates an example of a current state selection device 66 that includes five such switches, 62, 64, 72, 74 and 76, each corresponding to a respective current measurement device 26, 28, 54, 56 and 58. Each switch 62, 64, 72, 74 and 76 can be suitably adjusted as described with respect to FIG. 4.

In one embodiment, the current state selection device 66 can include one or more group assignment switches, shown as 71, 73, 75, 77 and 79. The group assignment switches 71, 73, 75, 77 and 79 allow the user to assign each appliance being monitored by a current measurement device to a group. This allows for the monitoring of appliances individually, or together with other appliances. As is shown in FIG. 7, the switches 62 and 64 are associated with a first group, switches 72 and 74 with a second group and switch 76 by itself in another group. The aspects of the disclosed embodiments allow for the groupings to be established in any suitable fashion.

In one embodiment, the current state selection device 66 includes a group selection switch 78. The group selection switch 78 can be used to select a particular group to be monitored, as is otherwise described herein. The group selection switch 78 can be any suitable selector and can include a spin wheel, rotary dial, push button switch, electronic switch or such other suitable selector or switching device that allows a single output to be selected from one or more inputs. In one embodiment, the groups can be systematically or randomly scanned during a power measurement phase. Thus, the power measurements for each group for each state can be determined as is described herein. In one embodiment, the process can be repeated to identify optimal groupings of devices based on power consumption.

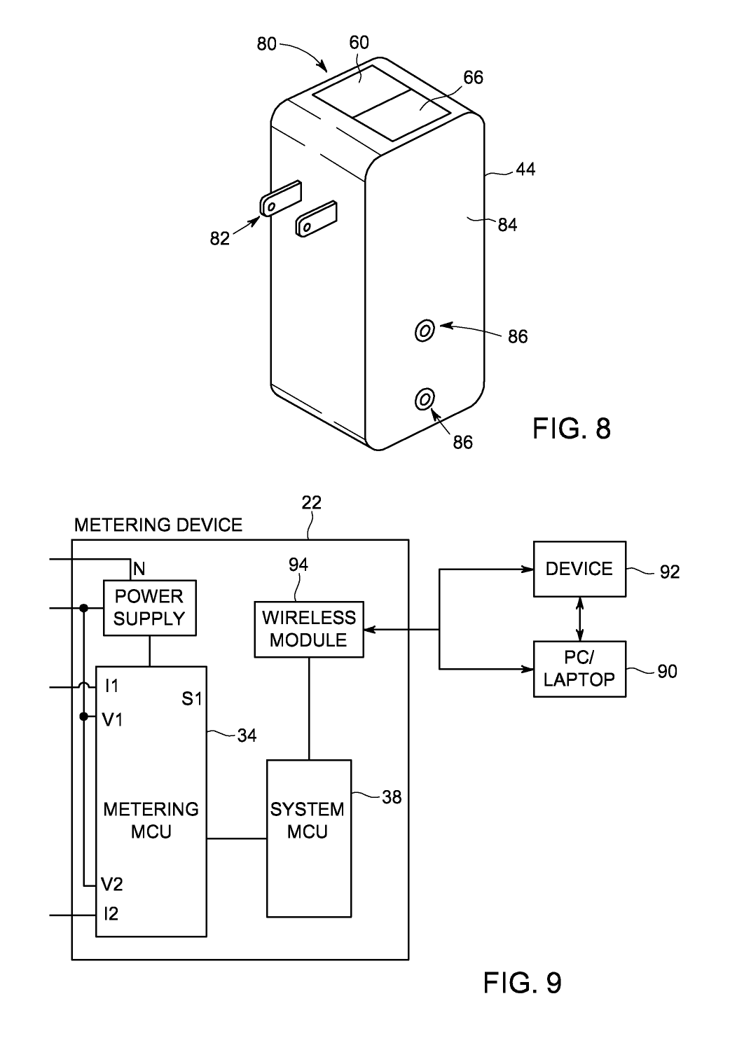

FIG. 8 illustrates one example of a metering device 10 in the form of a wall mountable unit 80. As shown in FIG. 8, the unit 80 includes a plug 82, which in this example is shown as a standard two prong plug, adapted to be received in a conventional outlet. In one embodiment, the plug 82 could be a standard three-prong plug unit. In alternate embodiments, any suitable plug can be used. The wall mountable unit 80 takes the shape of a “wall wart” that is can be plugged into a wall outlet which supports the unit 80 as well as provides power thereto.

The unit 80 includes a housing 84 in which the components of FIG. 1 such as the power supply 30, metering microcontroller unit 34, system controller 38, communication interface 56, etc., may be housed. In one embodiment, where the unit 80 includes user manipulated selection devices 60 and 66, the selection devices 60 and 66 can be located on suitable outside surfaces of the housing 84 that allow ease of user access. First and second current input ports 86 and 88 are provided for connection to the current measurement devices shown in FIGS. 1 and 6, such as current transformers 26, 28 or the like, for receiving a voltage/current reading. The user interface 44 from FIG. 1 can be suitably positioned on a surface of the housing 84 to allow for user interaction. Alternatively, the user interface 44 may be remote from the unit 80 and utilize a communication interface integral with the unit 80 for connecting the unit 80 to the remote user interface. For example, referring to FIG. 9, in one embodiment, the unit 80 could include a suitable connection or coupling to a home computer 90 or cell phone or other device 92 having a user interface could be adapted to communicate with the unit 80 for operation thereof. The connection or coupling could be a hard wire connection, in the form of a port or plug, or a wireless connection, where the unit 80 includes a wireless communication module 94. The wireless module 94 could be part of the system controller 38 shown in FIG. 1, or a separate unit. In one embodiment, the user can utilize the computer 90 or device 92 to set the initial configuration state 100 of the device 22 referred to in FIGS. 3 and 5, as well as execute the processes and adjust the states of the selection device 60, 66 as described with respect to FIGS. 2-7.

An embodiment of the disclosure may be embodied in the form of computer-implemented processes and apparatuses for practicing those processes. Embodiments of the present disclosure may also be embodied in the form of a computer program product having computer program code containing instructions embodied in tangible media, such as floppy diskettes, CD-ROMs, hard drives, USB (universal serial bus) drives, or any other computer readable storage medium, wherein, when the computer program code is loaded into and executed by a computer, the computer becomes an apparatus for practicing the invention. Embodiments of the disclosure also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing aspects of the disclosure. When implemented on a general-purpose microprocessor, the computer program code segments configure the microprocessor to create specific logic circuits. A technical effect of the executable instructions is to calculate an energy supply factor and select an available energy supply source based upon a desired criterion.

The aspects of the disclosed embodiments are generally directed to a power measurement system and device that can effectively measure power consumption in a single or polyphase environment, in multiple power connection configurations and when voltage and current phase connections are incorrect. Through the use of selection devices such as switches, the appropriate power configuration state can be determined, which includes determine if the line inputs L1 and L2 are reversed, or the current measuring device such as a current transformer, is installed backwards. By optimizing the calculation of the power consumed, which includes a power calculation for each possible power configuration state, and accurate measurement of power consumption can be made.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A power measurement device comprising:
a controller configured to receive a voltage supply input signal from a supply voltage and a current measurement input from input current sensor; and
a meter state selection device coupled to the controller, the meter state selection device comprising one or more state settings, each state setting corresponding to at least one potential configuration state of the supply voltage and input current sensor,
the controller comprising a memory in communication with a processor, the memory comprising program instructions for execution by the processor to:
calculate a value of power consumed for each of said potential configuration states;
determine a power supply configuration state in which the calculated value of power consumed is at a maximum; and
set a state of the meter state selection device to correspond to the power supply configuration state associated with the maximum value of power consumed.

2. The power measurement device of claim 1, wherein the voltage supply input comprises a first and second power supply input leg, and each state of the meter state selection device corresponds to a phase of each power supply input leg.

3. The device of claim 1, wherein the memory further comprises program instructions for execution by the processor to automatically change the state of the meter state selection device and determine the state in which the power consumed is at the maximum value.

4. The device of claim 1, wherein the meter state selection device comprises a manually activated switch.

5. The device of claim 1, further comprising:
a current transformer state selection device coupled to the controller, the current transformer state selection device comprising one or more state settings corresponding to a state of the current measurement input, and wherein the memory further comprises program instructions for execution by the processor to:
calculate a value of power consumed for each state setting of the current transformer state selection device in combination with each power configuration state of the device;
determine the state setting for the current transformer state selection device and the state setting for the meter state selection device in which the power consumed is at the maximum value; and
set the meter state selection device and the current transformer state selection device to the states in which the power consumed is at the maximum value.

6. The device of claim 5, wherein the memory further comprises program instructions for execution by the processor to automatically change the state of the meter state selection device and the current transformer state selection device and determine the state in which the power consumed is at the maximum value.

7. The power measurement device of claim 5, further comprising a current transformer measuring device, the current transformer measuring device providing the current measurement input, wherein the current transformer state selection device comprises a switch, the switch being configured to change a measurement state of the current transformer measuring device.

8. The power measurement device of claim 7, wherein the switch changes the measurement state of the current transformer measuring device between a power received state and a power delivered state.

9. The power measurement device of claim 7, further comprising a group assignment device, the group assignment device being configured to select one or more current measurement devices for assignment to a group.

10. The power measurement device of claim 9, further comprising a group selection switch, the group selection switch being configured to select a group of current measurement devices for measuring the power consumption of the group.

11. A system for measuring power consumption of a device coupled to an AC power source, comprising:
a controller comprising at least one voltage input for receiving a voltage from the AC power source to which the device is connected and at least one current measurement input for receiving values of measured current being drawn by the device, the controller further comprising a memory in communication with a processor, the memory comprising program instructions for execution by the processor to calculate a power consumption of the device based on the at least one voltage input and the at least one current measurement input; and
a meter state selection device coupled to the controller, the meter state selection device being configured to change a state of the at least one voltage input for calculating the power consumption of the device, the memory comprising program instructions for execution by the processor to:
calculate the power consumption for each state of the voltage input as set by the meter state selection device;
determine a state of the voltage input in which the power consumption is at a maximum value; and
set a state of the meter state selection device to correspond to the state of the voltage input in which the power consumption is at the maximum value.

12. The system of claim 11, further comprising a current transformer for providing the at least one current measurement input and a current transformer state selection device coupled to the controller, the current transformer state selection device being configured to set a state of the current transformer, the memory further comprising program instructions for execution by the processor to:
calculate the power consumption of the device for each state of the current transformer as set by the current state selection device in combination with each state of the voltage input set by the meter state selection device;
determine a maximum value of the calculated power consumption;
determine a state of each of the current transformer selection device and meter state selection device in which the calculated power consumption is at the maximum value.

13. The system of claim 12, wherein the AC power source comprises first and second power supply lines, the controller being coupled to each of the first and second power supply lines.

14. The system of claim 13, further comprising a first current transformer connectable to the first power supply line and a second current transformer connectable to the second power supply line, the first and second current transformers coupled to respective current measurement inputs of the of the device.

15. The system of claim 14, further comprising a current transformer grouping device, the grouping device being configured to group one or more current transformer for measuring a power consumption of the group.

16. A computer program product for determining a power supply configuration state of a load coupled to a power measurement device, the computer program product comprising:
computer readable code means, the computer readable program code means when executed in a processor device, being configured to:
calculate a value of power consumed for each power supply configuration state of the load;
determine a power configuration state of the load in which the power consumed is at a maximum value; and
set a state of the power measurement device to correspond to the power configuration state with the maximum power consumed value.

17. The computer program product of claim 16, wherein the computer program code means when executed in the processor device is further configured to determine the power configuration state in which the power consumed is at the maximum value by:
changing a setting of a phase of a power input to the power measurement device; and
calculating the power consumed for each phase setting.

18. The computer program product of claim 16, wherein the computer program code means when executed in the processor device is further configured to determine the power configuration state in which the power consumed is at the maximum value by:
changing a setting of a current measurement input to the power measurement device; and
calculating the power consumption for each setting of the current measurement input in combination with each power input phase setting.
